(19) United States
(12) Patent Application Publication
(10) Pub. No.: US 2006/0206217 A1
(43) Pub. Date: Sep. 14, 2006

(54) PLC tool device

(75) Inventor: Yutaka Fujii, Mishima-shi (JP)

Correspondence Address: FOLEY AND LARDNER LLP;SUITE 500, 3000 K STREET NW, WASHINGTON, DC, 20007, US

(73) Assignee: OMRON CORPORATION

(21) Appl. No.: 11/362,283

(22) Filed: Feb. 27, 2006

(30) Foreign Application Priority Data
Feb. 28, 2005 (JP) P2005-052232
Feb. 13, 2006 (JP) P2006-034850

(51) Int. Cl. G05B 11/01; G05B 19/42

(52) U.S. Cl. 700/18; 700/86; 700/87

(57) ABSTRACT

The present invention provides a PLC tool device that can extract a power source unit from current consumption calculated by information of a unit configuration, can let a user to easily know a width of a rack composing a PLC, and can provide information for determining whether the extracted power source unit is appropriate or not. The PLC tool device comprises a unit information storing section that stores “current consumption and width of a unit” and “supply current and width of a power source unit” as associated with each other, extracting section for calculating a total amount of current consumption for every rack composed of plural units integrally coupled, by an access to the unit information storing section based upon the unit configuration for constructing a PLC system selected by a user, and extracting a power source unit that can cope with the calculated total amount of current consumption, and a selection screen (see figures) of a power source unit by which optional power source unit can be selected from the power source units extracted by the extracting section. The width for every rack is obtained by an access to the unit information storing section based upon the width of the selected power source unit and the width of the selected unit from the unit selection screen, and the selected power source unit, current consumption and the obtained width are displayed. When the power source unit is changed, the width is recalculated, and the result is re-displayed.

### BACKGROUND OF THE INVENTION

1. Field of the Invention

The present invention relates to a PLC tool device used for constructing and designing a PLC system, and more particularly to a PLC tool device that selects a power source unit which can appropriately be used in a PLC system that is composed of a combination of respective units selected from selection information of various units used for the PCL system that is to be constructed and designed, when a PLC system is constructed and designed.

2. Description of the Related Arts

A PLC (Programmable Logic Controller) that controls a FA (Factory Automation) system installed in a manufacturing field such as a production factory is composed of a combination of various plural units, such as a CPU unit that executes a calculation based upon a control program, an input unit to which input devices such as sensors or switches are connected and which takes in on/off signals of these input devices as an input signal, an output unit to which output devices such as actuators or relays are connected and which sends an output signal to these output devices, a communication unit connected to a host terminal device or the like to send or receive information to or from the same, a power source unit for supplying power source to the respective units, and the like.

The CPU unit has a program memory for storing a control program, a data memory for storing the input signals received from the input unit and the output signals that are the result of the operation of the control program, and a processor (CPU) that executes the operation based upon the control program. The control program in the CPU unit is created with, for example, a ladder language, which is expressed by a ladder chart, by a user of the PLC who operates a programming tool device, before the PLC is started. The symbol in the ladder chart is converted into an instruction word by the programming tool device, and an operand according to each CPU unit is defined, whereby the created user program is downloaded to the target CPU unit. The processor section in the CPU unit sequentially reads out the instruction word of the user program from the program memory, and reads out the information of the input signal from the data memory based upon the address of the memory in accordance with the operand of this instruction word. It then logically operates this data in accordance with the user program, stores the result of the operation in the data memory, and then, outputs the stored result of the operation to the output unit as an output signal. The processor section in the CPU unit executes the input signal reading process, user program executing process and output process of the output process cyclically.

A user should consider what unit configuration the PLC takes suitable for executing the created user program, in simultaneous with, before or after the programming operation by the programming tool device. Specifically, the user has to select desired units, among the available various units, meeting the requirements, and to sufficiently examine how is the most preferable layout of the selected units, before actually constructing the PLC. More specifically, it is necessary to construct the PLC in such a manner that the type and the number of the input unit are selected so as to secure the input portions matching with the number of the input devices, the type and the number of the output unit are selected so as to secure the output portions matching with the number of the output devices, the type and the number of the CPU unit having a processing capability matching with the demand of the processing speed of the PLC are selected, the communication unit is selected with the type of the used network, and an analog operation unit, high-function processing unit or the like is selected in accordance with the content of the control of the whole system. The performance, capability, or the like of each unit is described in a catalog or manual. Accordingly, the user selects the unit configuration meeting various requirements by referring to the manual or the like, to thereby construct the PLC.

The selection of the power source unit is important upon constructing the PLC as described above. The power source unit generally gives electric power to each unit. Therefore, it is necessary to select a rated power source unit that satisfies a total of current consumption of each unit. This is because the rating of the power source unit is different depending upon the type of the unit. The rated current (current consumption) of a power source unit is written on a manual or the like. Accordingly, the user selects a power source unit satisfying the aforesaid various requirements to construct the PLC while referring to a manual or the like, upon selecting a power source unit. A user has to consider the required unit configuration, while considering the performance or capability of each unit in accordance with the used state or the content of the control of the PLC. Further, referring to a manual is troublesome.

Meanwhile, there are two types of the configuration for combining each unit in the PLC. One of them is a type for connecting each unit by using a base unit, while the other one is a type for connecting each unit by using a connector. The base unit connection type is such that predetermined slots are formed at a planar base unit, and desired units are attached in parallel to the slots, whereby each unit is electrically and mechanically coupled to each other. This type is also called as a building-block type. This base unit has wired therein a PLC bus for executing data communication between each unit in the PLC and power source lines for supplying power source to each unit. Each unit accepts the supply of power source via the electric power source lines of the base unit, and can perform data communication via the PLC bus of the base unit. In the connector-connection type, connectors are arranged at both side faces of each unit for electrically and mechanically coupling each unit. The PLC bus (coupled to the connector) wired in each unit is made conductive by coupling the connectors. A DIN rail attaching structure is provided at the back face of each unit in the connector-connection type. Each unit is fixed in parallel via the DIN rail. The width of the PLC is specified by the width of the used base plate in the former case, while is specified by the number of the coupled units and the width of each unit in the latter case.

As described above, many units can be added on as coupled to one another in the latter case. Therefore, the number of the used units can optionally be set, so that the total length (width) of the PLC greatly varies depending upon the number of the coupled units. Accordingly, it is important to check beforehand whether the PLC constructed by combining desired units has the width that can be put in the field of the FA. Like the rated current (current consumption) of the power source unit, the performance or capability of various units, or the like, the width of each unit is also written in a manual or the like. Therefore, a user constructs the unit configuration satisfying the aforesaid various requirements by referring to the manual or the like. Specifically, a user should consider the unit configuration necessary for executing a user program, while considering both the width and current consumption. Further, the more the type of the selectable units increases, the more the number of referring to a manual increases, thus troublesome.

In order to solve this problem, there has been proposed a PLC system construction aiding tool disclosed in Japanese Unexamined Patent Application No. 2002-108421. In the invention disclosed in Japanese Unexamined Patent Application No. 2002-108421, the PLC system construction aiding tool displays, on a layout display screen, a rectangular unit image (image that looks like the actual unit) corresponding to the designated unit, the unit images being successively coupled to each other. Further, it numerically displays the total length (width) of the unit or total of the current consumption at the neighboring of the unit array constructed by coupling the unit images. Thus, the user can easily determine whether the current consumption or size is realizable or not by seeing the numerically displayed values.

In the PLC system construction aiding tool device disclosed in Japanese Unexamined Patent Application No. 2002-108421, a power source unit is firstly selected, and then, various necessary units are added on the screen, wherein the current consumption value of each unit or total width of all units are displayed, so that a user can confirm whether the constructed configuration is placed within the capability of the selected power source unit. In case where a user knows that the total current consumption value exceeds the total amount of current that can be supplied from the power source unit, it is assumed that another rack is formed. Specifically, a user operates the PLC system construction aiding tool device for adding one power source unit on the screen, and he/she connects predetermined units (remaining units by which the total current consumption exceeds the total amount of current that can be supplied from the power source unit) to the added power source unit to form another rack. This PLC system construction aiding tool device displays the total amount of the unit width for every rack on the screen. Accordingly, a user can find out the total amount of the current consumption of each unit for every rack constituting the PLC or the space required for arranging each unit of the rack in the field, thus useful.

However, the PLC system construction aiding tool device causes a user to firstly select a power source unit that is to be arranged at the leftmost of the rack configuration displayed on the screen, and then, causes a user to select and arrange various necessary units. In case where the total amount of the current consumption of each unit in the rack exceeds the total amount of current that can be supplied from the power source unit, it is necessary to reselect a power source unit in order to change the power source unit to a suitable one, which means that a user has to do again the operation on the tool device from the beginning.

### SUMMARY OF THE INVENTION

An object of the present invention is to provide a PLC tool device that can easily select an optimum power source unit after calculating a total amount of current consumption of each unit from unit configuration information, when selection information of various units used for a PLC system is registered, and a PLC system composed of the selected respective units is constructed and designed.

In order to accomplish the foregoing object, a PLC tool device according to the present invention is a PLC tool device used for constructing and designing a PLC system composed of a combination of various units and a power source unit, comprising: a control section; a display section; and a unit information storing section that stores a type information and a current consumption information of all units and a type information and a supply current information of all power source units; wherein the control section is configured to execute: a process for inputting type information of a plurality of unit used for a PLC system that is to be constructed and designed; a process for obtaining the current consumption information of the plurality of unit by an access to the unit information storing section based upon the inputted type information of the unit, and for calculating a total amount of current consumption of the plurality of unit; a process for extracting type information of a power source unit that supplies the total amount of current consumption based upon the supply current information stored in the unit information storing section; and a process for displaying the type information of the extracted power source unit on the display section.

In the PLC tool device according to the present invention, a CPU 13 in the embodiment corresponds to the control section, a display 12 corresponds to the display section, and a unit information storing section 15 corresponds to the unit information storing means. The “type information of each unit” and “type information of a power source unit” mean information for specifying the model of various units. The “type information” corresponds to the information of model in FIG. 3 and FIG. 4 in the embodiment. Different pieces of information are given to the respective units each having different specification (e.g., current consumption or width). The “block of the unit” indicates a range of units to which one power source unit supplies power. It corresponds to a unit of a rack in the embodiment. One rack is composed of one power source unit, and plural various units to which power is supplied from the power source unit. A block of the plural coupled units does not always correspond to a rack. In case where power is supplied from one power source unit to the plural units even if there are two blocks (apparently two racks) of the plural coupled units, this range is considered to correspond to the block of the unit. This is true of the following another means for solving problems.

The process for extracting a power source unit includes that at least one power source unit that can appropriately be used can be displayed for a reference. It also includes that plural types of the extracted power source units are displayed by a pull-down operation in the embodiment. When a power source unit that can appropriately be used in a PLC system that is constructed and designed by a user is selected with this display, the selected power source unit may be stored in a constructed and designed manner. This storage corresponds to a “registration of a power source unit” in the embodiment.

The “total amount of current consumption” is a total amount of current consumption of each unit in a block of plural coupled units. It corresponds to the maximum current consumption amount in the embodiment. The “supply current of a power source unit” may be the maximum supply current specified by the specification of this power source unit, may be the idealistic value in the design of the power source unit, or may be the value obtained beforehand by actually measuring the maximum supply current value that can withstand the actual use.

Another means to solve the problems is a PLC tool device used for constructing and designing a PLC system composed of a combination of various units and a power source unit, comprising: a control section; a display section; an input section; and a unit information storing section that stores a type information and a current consumption information of all units and a type information and a supply current information of all power source units; wherein the control section is configured to execute: a process for inputting a type information of a plurality of unit used for a PLC system that is to be constructed and designed; a process for obtaining the current consumption information of the plurality of unit by an access to the unit information storing section based upon the inputted type information of the units, and calculate a total amount of a current consumption of the plurality of unit; a process for obtaining the supply current information of a power source unit which is selected through the input section from the unit information storing section; and a process for comparing the obtained supply current information and the calculated total amount of the current consumption, and, in case where the relationship between the supply current information and the calculated total amount of the current consumption does not meet a predetermined condition, for displaying this situation on the display section, and, in case where the relationship between the supply current information and the calculated total amount of the current consumption meets a predetermined condition, for displaying this situation on the display section. With this configuration, a user can easily confirm through the display section whether the selected power source unit is a power source unit that can appropriately be used in the PLC system constructed and designed by a user.

Note that such configuration may be taken in which, when a power source unit that can appropriately be used in the PLC system constructed and designed by a user is selected from the display showing whether the selected power source unit satisfies the appropriate condition or not, this power source unit is stored as constructed and designed. This storage corresponds to “a registration of a power source unit” at S6 in FIG. 5 in the embodiment. Further, the process by the control section for storing the type information of a unit used in the PLC system corresponds to the registration of various units, i.e., S2 and S4 in FIG. 5, in the embodiment.

“The case satisfying the appropriate condition and the case not satisfying the appropriate condition” include the following meanings, for example. The first meaning is “the case in which the supply current of the power source unit is less than the calculated total amount of the current consumption” and “the case in which the supply current of the power source unit is not less than the calculated total amount of the current consumption”. The second meaning is “the case in which the supply current of the power source unit is not more than the calculated total amount of the current consumption” and “the case in which the supply current of the power source unit exceeds the calculated total amount of the current consumption”. The third meaning is “the case in which the supply current of the power source unit is less than the calculated total amount of the current consumption with some degree of allowance” and “the case in which the supply current of the power source unit exceeds the calculated total amount of the current consumption with some degree of allowance”. It is considered that a value obtained by multiplying some coefficient is utilized as an example of the allowance, such as “the case in which the supply current of the power source unit is less than 110% of the calculated total amount of the current consumption” or “the case in which the supply current of the power source unit exceeds 110% of the calculated total amount of the current consumption”.

In the PLC tool device, in case where the unit configuration is changed though the input section after the input of plural units, that are to be coupled to the PLC system to be constructed and designed, is completed in the input process by the control section, the process for calculating the total amount of the current consumption can be configured such that the current consumption information of the re-inputted unit is obtained by an access to the unit information storing means based upon the re-inputted unit, in order to calculate the total amount of the current consumption in the block of the plural coupled units. According to this, even if a change is made in constructing and designing the PLC system, a power source unit that can appropriately be used can be selected every time the change is made.

In the PLC tool device according to the present invention, the control section can be configured to execute a process for displaying a list of the type information and the supply current information of the extracted power source units; and a process for registering the fact that the type information of the selected power source unit can be used in the PLC system that is to be constructed and designed. This configuration corresponds to the display of plural extracted power source units by a pull-down operation in the embodiment.

The PLC tool device according to the present invention can also be configured such that the unit information storing section stores the type information, the current consumption information and the width information of all units constituting a PLC system and the type information, the supply current information and a width information of all power source units, and the control section further executes: a process for obtaining the width information of the selected units and the selected power supply unit used for the PLC system by an access to the unit information storing section, and for calculating the total width of the selected units and the selected power supply unit coupled in a rack; and a process for displaying the calculated total width on the display section. This configuration corresponds to the case of utilizing the width information in the embodiment.

The PLC tool device according to the present invention can also be configured such that the unit information storing section stores the type information, the current consumption information and the width information of all units constituting a PLC system and the type information, the supply current information and a width information of all power source units, and the control section further executes: a process for obtaining the width information of the selected units and the selected power supply unit used for the PLC system by an access to the unit information storing section, and for calculating the total width of the selected units and the selected power supply unit coupled in a rack; and a process for displaying the calculated total width on the display section. This configuration also corresponds to the case of utilizing the width information in the embodiment.

According to the present invention, a total amount of current consumption of each unit is calculated from unit configuration information, and an optimum power source unit can easily be selected based upon the calculated result, when a PLC system is constructed and designed.

### BRIEF DESCRIPTION OF THE DRAWINGS

FIG. 1 shows a view for showing one example of a PLC system;

FIG. 2 shows a diagram showing one example of a configuration of a PLC tool device;

FIG. 3 shows a view showing one example of a data structure of a unit information storing section;

FIG. 4 shows a view showing one example of a data structure of a unit information storing section;

FIG. 5 shows a flowchart showing a function of a CPU;

FIG. 6 shows a view showing one example of a display screen of a tool;

FIG. 7 shows a view showing one example of a screen of a unit configuration;

FIG. 8 shows a view showing one example of a screen of a unit configuration;

FIG. 9 shows a view showing one example of a screen of a unit selection;

FIG. 10 shows a view showing one example of a screen of a unit configuration;

FIG. 11 shows a flowchart showing a function of a CPU; and

FIG. 12 shows a view showing power source units, current consumption, and widths.

### DETAILED DESCRIPTION OF THE PREFERRED EMBODIMENT

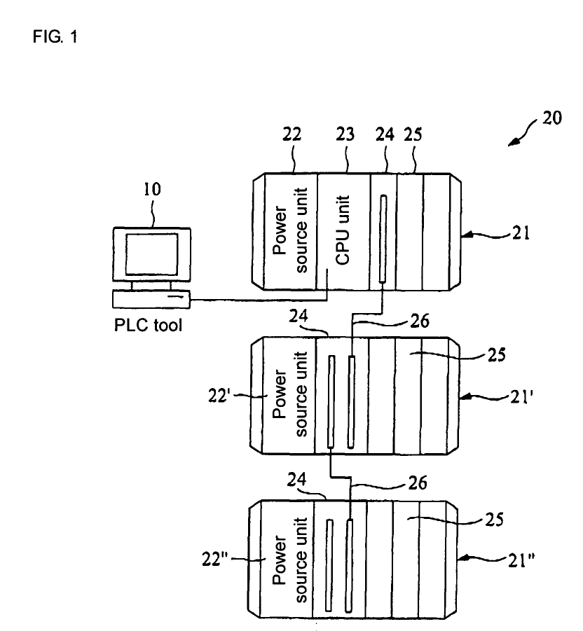

FIG. 1 shows one example of a PLC tool device 10 and a PLC system 20 that is to be set by the PLC tool device 10. The PLC system 20 comprises plural racks 21, 21′ and 21″. Each of the racks 21, 21′ and 21″ has each of power source units 22, 22′, 22″, wherein the unit composing the same rack accepts a power supply from the power source unit connected to this rack. One of the plural racks is a CPU rack 21 provided with a CPU unit 23. The CPU unit 23 in the CPU rack 21 manages (IO refresh or the like) each rack 21, 21′ and 21″. A repeater unit 24 for linking these racks 21, 21′ and 21″ so as to be communicable, and various units (IO unit, master unit, communication unit, high-function unit, or the like) 25 required for the PLC system 20 performing a desired control are coupled to each rack 21, 21′ and 21″. The power source units 22, 22′, and 22″ mounted to each rack 21, 21′ and 21″ may be the same type or may be the different type. Further, the repeater units 24 are linked by a predetermined wiring cable 26. Although three racks are coupled to construct the whole PLC system 20 in the figure, the number of the rack for constructing the PLC system 20 is of course optional. For example, only one rack (only the CPU rack 21) may be used.

The PLC tool device 10 has a PLC system construction aiding function for obtaining a suitable unit configuration upon constructing the PLC system 20 having an optional construction with the combination of various units and upon designing the PLC construction matching with the controlled subject. The tool device in this embodiment may be referred to as a PLC system construction aiding device or configurator. Upon constructing and designing the PLC system, the PLC tool device selects various units used for the PLC system that is to be constructed, selects a power source unit that can appropriately be used in the combination of the selected units, and registers the resultant. As apparent from FIG. 1, the PLC tool device 10 is made by installing a predetermined application program (tool) to a personal computer. Describing in relation to the present invention, the PLC tool device 10 selects units constituting the rack, creating information of the unit configuration other than a power source unit, calculates the width of the rack and total current consumption based upon the information of each unit used in the information of the unit configuration, displays the resultant, and finally selects a power source unit suitable for each rack, thereby deciding the whole construction of the PLC system. The PLC tool device 10 may of course have a function for setting various operations to an ordinary I/O unit and other units, or for downloading the set information to each device (unit) via a network.

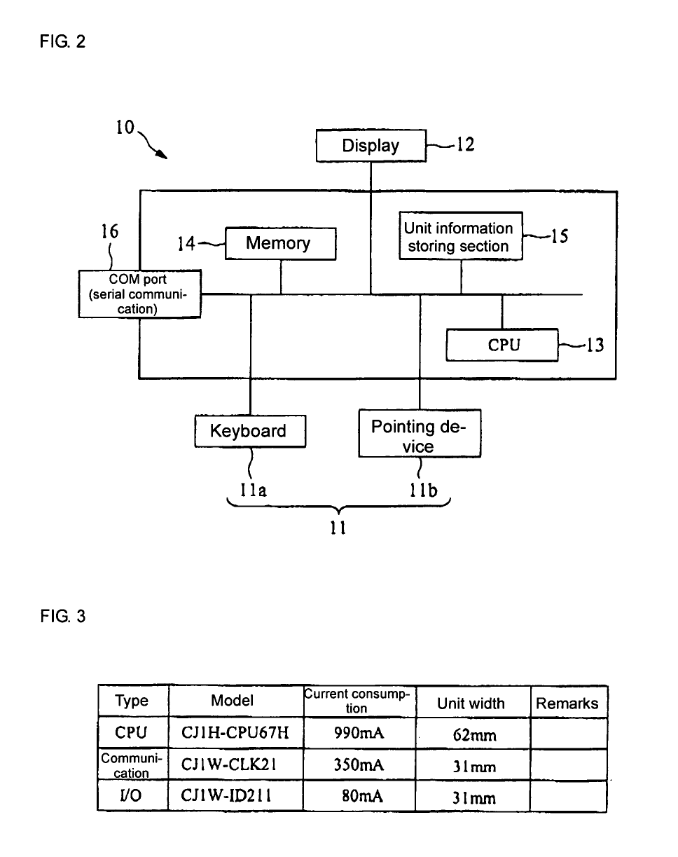

FIG. 2 shows an internal structure of the PLC tool device 10. As shown in FIG. 2, the PLC tool device 10 has, as an external device (man-machine interface), an input section 11 such as a keyboard 11a, pointing device 11b, or the like, and a display section 12 such as a display. It also has, as an internal device, a CPU (control section) 13 that executes various processes such as executing a system program or executing various operations to form information of the unit configuration; a memory (RAM) 14 that is suitably used as a work memory when the processing section 13 executes various processes such as operation or the like; a unit information storing section 15 that stores unit information (type information, current consumption information, width information, or the like) relating to each unit composing the PLC system; and a COM port 16 that is used when the information formed at the processing section 13 and set to various units composing the PLC system 20 is downloaded to the PLC system 20. The processing section 13 displays various input screens on the display section 12. It accepts the input of required information inputted by a user operating the input section 11, and decides the information of the unit configuration.

In the unit information storing section 15, unit information in which at least “type”, “model”, “current consumption”, “unit width”, “remarks” are associated for every unit, that is a component of the PLC, is stored in a table, as shown in FIG. 3. The “type” represents type information (name of the type) for specifying the type of the unit such as CPU unit, analog I/O unit, motion controller unit, position control unit, temperature controller, communication unit, or the like. The “model” represents a model name given by a manufacturer, or an identification number or model number for every type of a product. Since the model is generally a combination of alphabets or numerals, a user is difficult to intuitively grasp the content thereof only by seeing the model. In view of this, the information that is easy to be understood by a user may additionally be stored, such as a specific name or popular name. The “type information” in the claims is information indicating the distinction of the unit. It broadly corresponds to the “type” and corresponds to the “model” in a narrow sense. The “current consumption” is the value of the current consumption consumed for operating the unit. In general, the rated current written on a manual is stored. As the “unit width”, the width of the outer dimension of the unit is stored. The unit of numeral stored is defined as “mm”. In the column of “remarks”, optional information that does not belong to the above-mentioned basic items is stored. In the case of the I/O unit, for example, the used memory capacity (ch number) for the number of input portions or output portions is determined depending upon the type. Further, there are those using predetermined numbers of input portions and output portions such as the position control unit. These used channel numbers (number of portions) are stored.

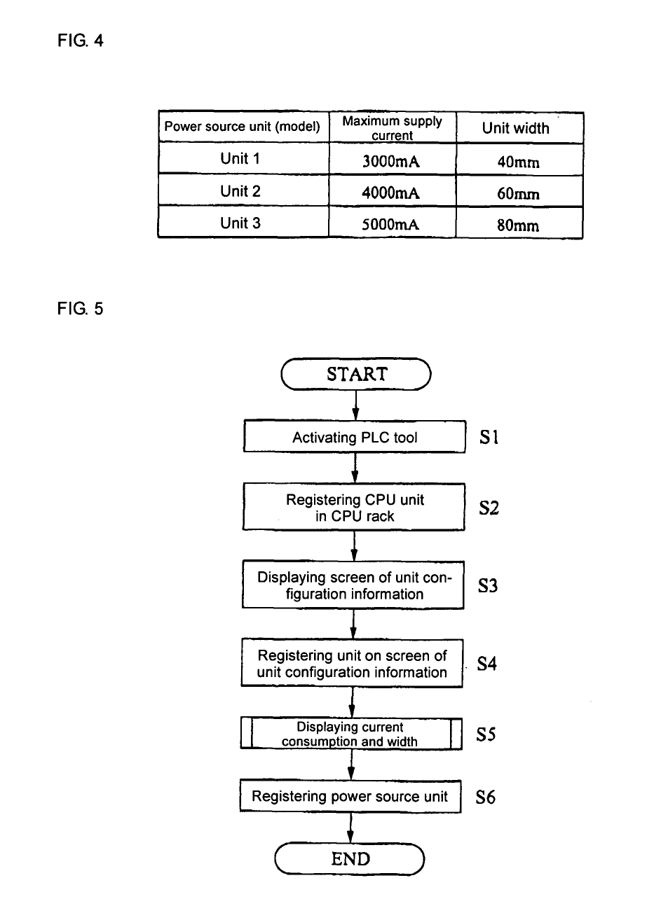

As for the unit type that supplies power such as a power source unit, unit information in which “model”, “maximum supply current”, and “unit width” of the power source unit are associated is stored in a table, as shown in FIG. 4. The reason why the unit information relating to the power source unit is also stored is as follows. There are various types of power source units having a different width. In general, the unit width tends to increase with the increase in the maximum supply current. The width of each rack is in relation to the unit width of the power source unit, and further, the maximum supply current of the power source unit connected to each rack should be set more than the total current of the unit composing the rack. Therefore, the power source unit is finally one of the important factors in order to decide the unit configuration of each rack.

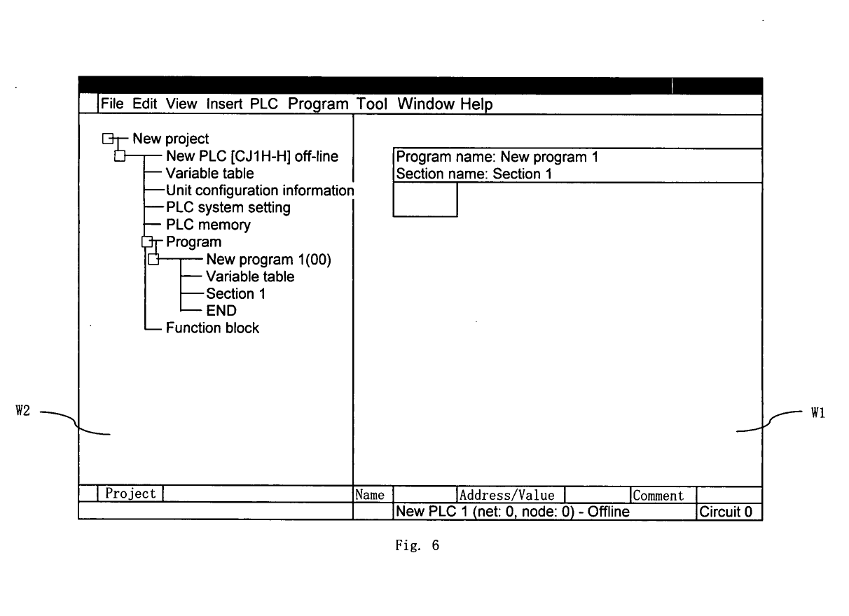

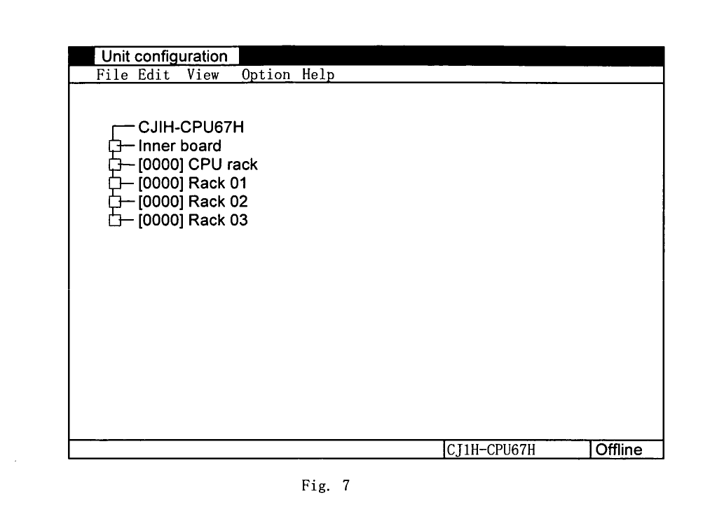

FIG. 5 is a flowchart showing a basic processing function executed by the processing section 13. Firstly, the PLC tool device 10 is activated (S1). The PLC tool device in this embodiment makes a process for registering the CPU unit in the CPU rack when activated (S2). Specifically, the PLC tool device displays on a dialog window screen a screen for asking a user about whether the PLC rack configuration is newly registered or not. The PLC tool device receives the input indicating the registration by the user operation via the input section. Then, the PLC tool device displays the screen for selecting the type of the CPU unit of the PLC to promote the input of the selection. The PLC tool device receives the input about the type information of the CPU unit by the user operation via the input section. Supposing that it receives the input indicating that the CPU unit of model “CJ1H-CPU67H” is selected. With this input, the PLC tool device registers the type of the target CPU unit and the initial information of the CPU rack configuration, and displays the basic screen shown in FIG. 6. By this registration of the CPU unit, the PLC tool device registers the type of the CPU unit corresponding to the CPU unit 23 in the CPU rack 21 in the PLC system shown in FIG. 1. As shown in FIG. 6, the basic screen of the display 12 is composed of the rightward screen W1 for creating the user program (ladder chart) and the leftward screen W2 for selecting a project of the project information relating to the PLC configuration that is to be registered now. The user operates the pointing device 11b to select the “unit configuration information”, that is tree-displayed on the project selection screen W2, by a double click, or the like. According to this operation, the program proceeds to a step for registering various units that are intended to be arranged in the CPU racks 21, 21′ and 21″ in the PLC system in FIG. 1.

The starting operation at S1 is not limited to the above-mentioned case. Various methods can be applied, for example, the menu screen having the names of the used tools listed up is displayed on the display 12, and the PLC tool of the present invention is selected from this menu screen and started.

When it is recognized that the aforesaid “unit configuration information” is clicked, the screen of the unit configuration information shown in FIG. 7 is displayed (S3). This embodiment can handle the PLC system to which a maximum of four racks including the CPU rack can be connected. Therefore, in the initial screen, only the “CPU rack”, “rack 01”, “rack 02”, and “rack 03” are displayed in a tree-like manner, wherein the unit configuration of each rack is displayed in a closed state. The “CPU rack” corresponds to the CPU rack 21 in FIG. 1, the “rack 01” corresponds to the rack 21′ in FIG. 1, and the “rack 02” corresponds to the “rack 21” in FIG. 1. Although the “rack 03” is not shown in FIG. 1, it is a factor to be constructed and designed.

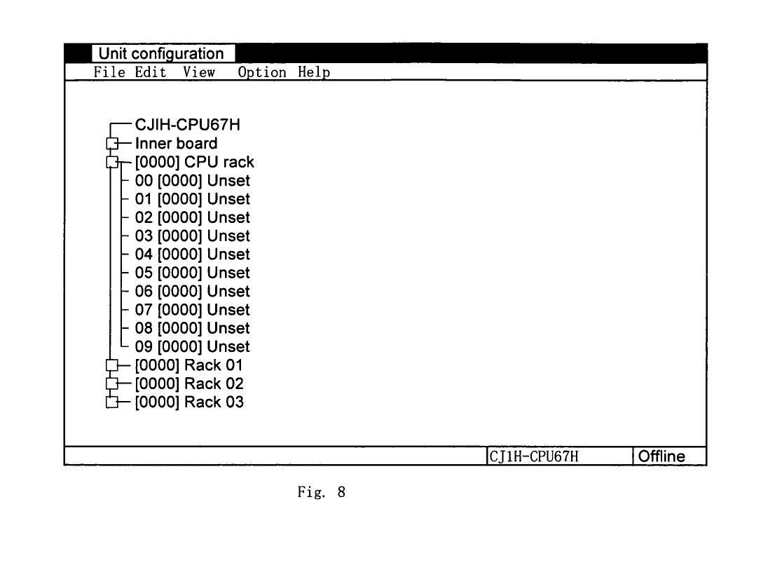

The program proceeds to a step for registering various units that are to be incorporated into each rack on this screen of the unit configuration information (S4). Specifically, in case where the rack that is to be constructed and designed is closed like the initial screen, the “+” button marked at the head of the used (set) rack in the tree-display is clicked to open the appropriate rack as shown in FIG. 8. FIG. 8 shows that the CPU rack is opened. As shown in the figure, a maximum of ten units (as for the CPU rack, ten units except for the CPU unit) can be registered to each rack. It is of course possible to set that more than ten units can be registered. However, the following explanation is made for the case in which the registered units are ten. Since the units other than the CPU unit in the CPU rack are not registered, the tree-display of each of ten units is all displayed as “unset”.

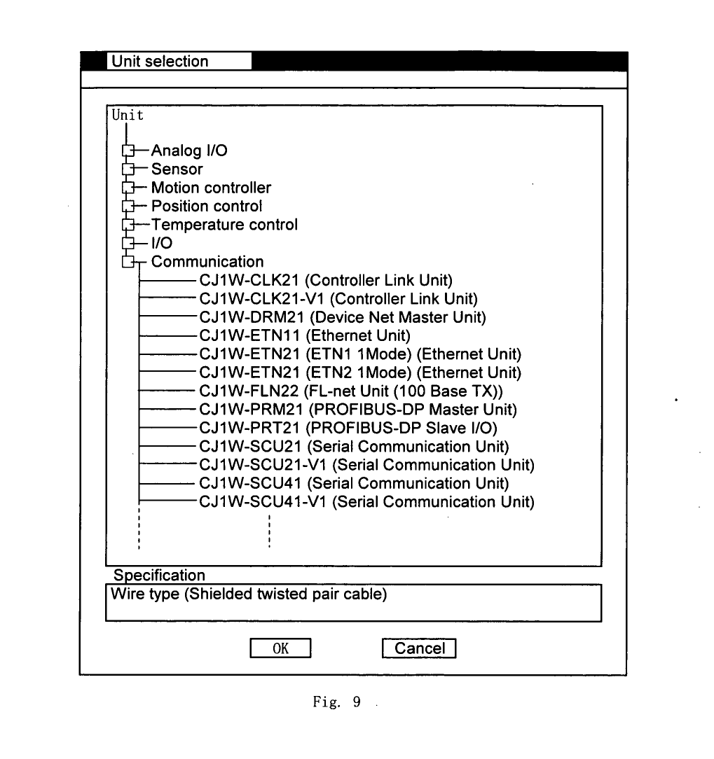

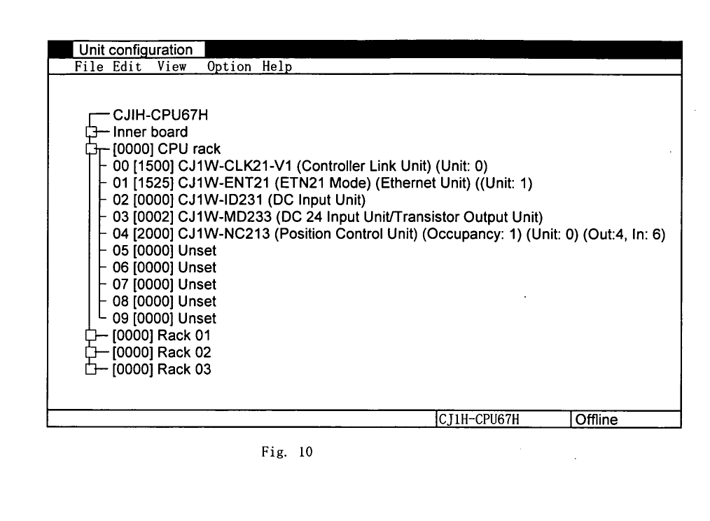

Subsequently, the actual unit registering process is performed. In the case of a new registration, the user operates the pointing device 11b to select the field of “unset” in the tree-display. When the selected “unset” is double-clicked, the unit selection screen shown in FIG. 9 is displayed in a separate window. The PLC tool device 10 displays the unit selection screen by referring to the unit information storing section 15. This screen displays units, which are to compose the PLC, in a tree-structure for every type. For example, various units such as “analog I/O unit”, “sensor unit”, “motion controller”, “position control unit”, “temperature control unit”, “basic I/O unit”, “communication unit”, and the like, are displayed as shown in FIG. 9. When the PLC tool device 10 receives the click operation of the pointing device 11 b by the user at the “+” in the tree-display screen, it displays the model information of this unit by referring to the unit information storing section 15. The user utilizes this screen to search a unit that he/she intends to use from a unit list, select the same, and register the same. The example of FIG. 9 shows that the unit whose type is the “communication unit” and whose model is “CJ1W-CLK21-V1” is selected. As apparent from FIG. 9, the unit selection screen displays the tree-display in which the units are classified for every type. Therefore, the user is easy to select the target unit. Upon displaying the units as classified for every type, the “type” information stored in the unit information storing section 15 is utilized in this embodiment. However, it is not limited thereto. For example, a type of a unit may be managed by another table. In this case, the field “type” may be eliminated from the table structure in the unit information storing section 15.

The user operation will be explained in detail. The user operates the input section 11 such as the pointing device 11b or the like to click the displayed unit that is to be used. With this operation, the control section 13 reversely displays the name of the model of the clicked unit to show that it is temporarily selected. In simultaneous with this, the control section 13 reads out the information associated with the unit from the unillustrated database relating to the unit, and displays the read-out information on the window W3 of “specification”. When “OK” button is clicked, the unit that is temporarily selected is registered to the place designated on the screen of the unit configuration information, and the information such as the model or the like is additionally displayed.

FIG. 10 shows the unit configuration screen after the aforesaid unit registering process is repeated plural times. As apparent from FIG. 10, the model of the unit is displayed in case where the unit has already been registered, while “unset” is displayed in the case of the non-registration. In the case of the registered unit, the information of the “model” stored in the unit information storing section 15 is read out and displayed. The name registered at the field of the “model” in the unit information storing section 15 is displayed on the specific name represented by ( ) after the model. Although the specific illustration is not shown, only a model may be registered to the unit information storing section 15, and a table in which a model and specific name are associated with each other is separately prepared, wherein the necessary information is read out and displayed from the table. Moreover, the information of the number stored in the “remarks” may be displayed.

In case where the unit already registered on the screen of the unit configuration information in FIG. 10 is exchanged to another unit, the unit to be exchanged is selected and deleted by a click on the screen of the unit configuration information in FIG. 10 to be temporarily “unset”, and thereafter, the processing section 13 may execute the above-mentioned new registration. Alternately, a changing process may be executed to change to another unit. It should be noted that, since the used area (channel) of the memory is automatically set (the numeric value indicated by [ ] written before the model) in this embodiment, the change to a unit that can succeed the information, i.e., the change to a unit of the same type, is only allowed. Whether it is the exchangeable unit or not is found by referring to the “remarks” or the like stored in the unit information storing section 15, so that the corresponding units are only extracted and displayed. In case where the memory is not automatically set, the embodiment can take a configuration to allow the change to all units.

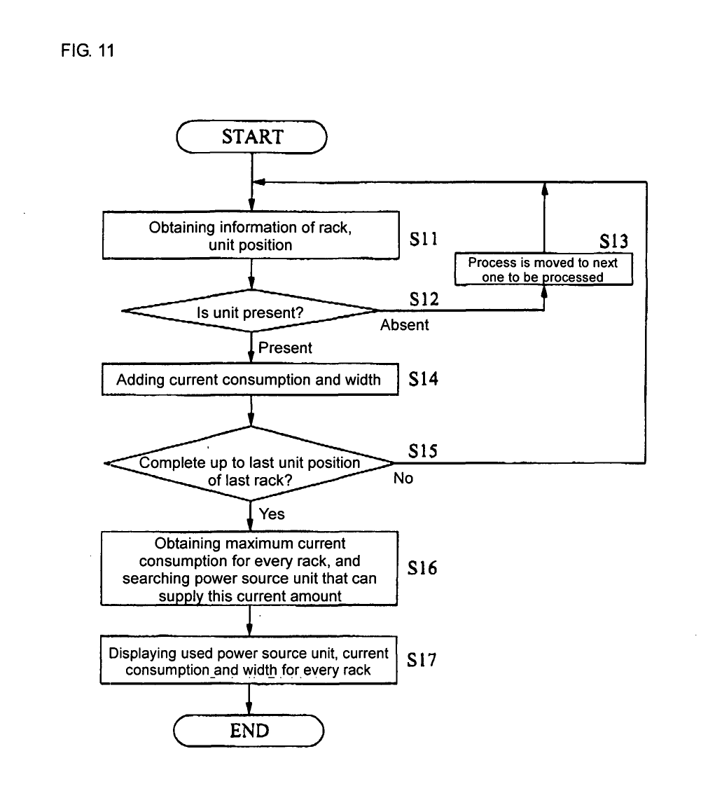

When the registration of all units is completed as a result of the operation for registering various units at S3, the program proceeds next to a process for selecting and registering a power source unit. This process executes a process for calculating the current consumption and width of various units registered for every rack and displaying the total value, and a process for registering a power source unit (S5, S6). At S5 and S6, a flowchart specifically shown in FIG. 11 is executed. One example of the operation for moving from step S4 to this process will be explained. When the “option” at a tool bar on the screen of the unit configuration information in FIG. 9 is selected, for example, a menu for executing various processes is displayed in a pull-down manner. The menu includes an item of “current consumption and width”, so that, by selecting this item, the step 4, i.e., the flowchart shown in FIG. 11 is started. Another operation may be adopted. For example, an operation button of “current consumption and width” is provided in the screen of the unit configuration information in FIG. 9, and the flowchart shown in FIG. 11 may be started by clicking this button by the pointing device 11b.

When the processing section 13 of the PLC tool device 10 starts the execution of the flowchart shown in FIG. 11, the processing section 13 obtains one by one the information from the unit position (00) at the head of the head rack (CPU rack) (S11), for determining the presence or absence of the unit (S12). In case of the absence of the unit (in case where the answer at the step S12 is No), the position of unit to be processed is transferred to the next position (S13), and the information of the unit position is obtained (S11). In the process at the step S13, it is determined whether the unit position is 09 or not that is the final value of the rack, and if it is less than 09, only the unit position is incremented by one. In this case, the number of the rack is unchanged. Then, if the unit position becomes 09, which means that this rack is the last, the unit position is returned to 00, and the next rack becomes the target to be processed. Specifically, in case where the “CPU rack” is currently the target to be processed, the process is made next to the “rack 01”, and similarly, the process is performed in the order of “rack 02” and “rack 03”. Accordingly, in the embodiment, the unit position “09” of the “rack 03” is the last position.

In case where the answer at the step S12 is Yes, i.e., it is determined that there is a unit, the processing section 13 jumps to the step S14 so as to access to the unit information storing section 15 for obtaining the current consumption and width of this unit and to add the obtained respective values to the current values. The processing section 13 stores each value of the added result to the memory 14. Note that the adding process is executed in the same rack. The processing section 13 repeatedly executes the aforesaid processes (S11 to S14) up to the last unit position of the last rack (S15). It should be noted that, in the adding process of the current consumption and width in the CPU rack, the CPU unit in the CPU rack (the CPU unit of the model “CJ1H-CPU67H” at the top of the tree-display in FIGS. 8 and 10) in the CPU rack also has to be a target. The processing section 13 accesses to the unit information storing section 15 for obtaining the information about the current consumption and width of the CPU unit, and adds the obtained result to the current consumption and width of the CPU rack, in the processes of S11 to S14 executed to the CPU unit in the CPU rack.

After the processes are executed up to the last unit position of the last rack (Yes determination at S15), the total current consumption and width for every rack are calculated according to the execution of the step S14 and stored in the memory 14. Then, the processing section 13 searches a power source unit that can supply the total current consumption based upon the total current consumption (maximum current consumption) for every rack (S16). Specifically, the processing section 13 searches the maximum current supply amount on the table of the power source units stored in the unit information storing section 15, extracts the model information of the power source units having the rating more than the total current consumption, and lists them up. The result of the extraction is stored in the memory.

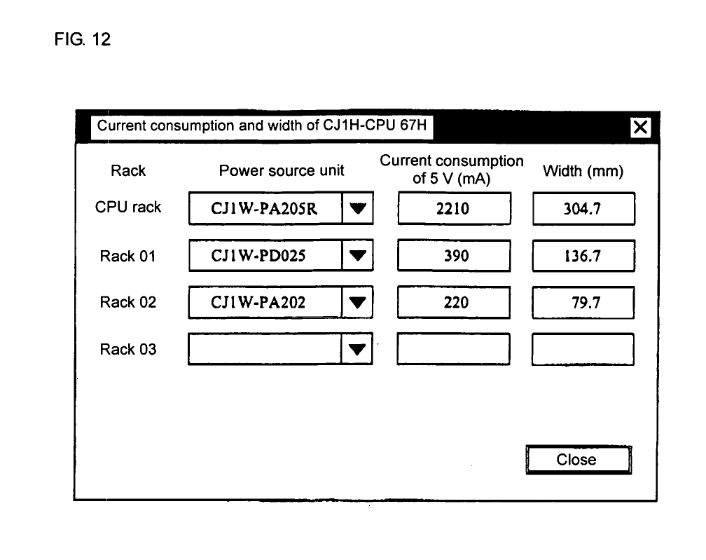

Subsequently, the processing section 13 displays the information about the sum of the current consumption and the sum of the width of all units for every rack, and the model information of the applicable power source unit (S17). FIG. 12 shows the specific example of this display screen. This screen displays rack specifying information such as rack numbers, model information of applicable power source units, information of the sum of the current consumption of all units in each rack, and the sum of the width of all units in each rack. The default in the listed applicable power source units is the power source unit having the smallest maximum supply current amount. The processing section 13 accesses to the unit information storing section 15 for obtaining the width information of the displayed power source unit, executes the process for adding the obtained width of the power source unit to the total rack width obtained at the step S14, and displays the resultant on the field of the rack width. This rack width is the total of the width of the power source unit itself and the widths of various units coupled to this rack. Since the total current consumption is unchanged depending upon the power source unit, at S17 the obtained total current consumption is displayed as it is for every rack with the execution of the step S14. FIG. 12 represents that the sum of the current consumption of various units of the rack number 1 is “2210 mA”, and the sum of the widths is “304.7 mm”. Further, it represents that the power source unit of “CJ1W-PA205R” is applicable to such used state of the PLC.

In FIG. 12, the field of the rack 03 is blank. This is because no unit is registered to the rack 03 in the unit setting process using the screen of the unit configuration information in FIG. 9. This can be clear that the value of the used memory indicated by [ ] is the same as that of the rack 02. Specifically, FIG. 12 shows the example of the PLC system shown in FIG. 1 composed of three racks.

Another power source unit can be selected and registered in a pull-down menu manner in the display field of a power source unit in FIG. 12. When the triangular button in the display field of a power source unit is operated by the pointing device 11b, the processing section 13 extracts all pieces of model information of all applicable power source units extracted in S16, and displays the same by a pull-down menu manner. In case where a user changes the power source unit to another power source unit displayed in the field of a power source unit, it is necessary to recalculate the total amount of the widths once obtained at S17. Therefore, the processing section 13 recalculates the rack width based upon the width information of the newly selected power source unit, and displays the result in the field of displaying the rack width. If change to another power source is made, the total amount of the widths is recalculated whenever another change is made. As a modified example, the rack width (the total amount of the widths in case where this power source unit is selected) may be calculated beforehand for every model of the applicable power source units, and the result of the calculation may be displayed if the power source unit is changed to another one.

Accordingly, various units installed to the rack is firstly registered, then, the total value of the current consumption of the units in the rack is obtained; and thereafter, the applicable power source unit to the rack having the registered units can easily be selected and registered. Compared to the conventional example in which a power source unit is firstly registered, and then, units for the rack are registered, the PLC tool device in this embodiment has a substantial function for registering a power source unit, so that a user can conveniently use it.

For example, the power source unit displayed as a default has the smallest maximum supply current amount that can cope with the total current consumption of this rack. Therefore, even in case where a user plans to supply power from a power source unit to each unit with some degree of allowance, the PLC tool device in this embodiment has a substantial function in which he/she can easily select another power source unit having the maximum supply current amount that is great to some extent.

The rack width information is also displayed upon registering a power source unit, whereby the optimum power source unit can be decided considering the width of the field to which the rack is installed. Even in case where another power source unit having the great maximum supply current amount is selected, the width of the rack using another power source unit is immediately recalculated and displayed. Therefore, a user can instantly understand whether the rack constituted by another power source unit can be installed to the actual field or not, and can determine whether it can be used or not.

As described above, in this embodiment, a unit composing each rack is firstly set, and a power source unit suitable therefor is selected. Therefore, in case where the total current consumption of the units installed to the same rack is increased, the power source unit having the maximum supply current matching with the increased current consumption is only selected.

Although a power source unit having the usable smallest maximum supply current is displayed as a default, the invention is not limited thereto. A power source unit having a greater maximum supply current with some degree of allowance may be displayed as a default.

Although not shown, the rating (maximum supply current) of the displayed power source unit may also be displayed. This can tell a user what allowance there is to the current consumption, so that the selection of a power source unit larger than necessary is prevented, even if there is an allowance in the width dimension.

In the embodiment, the processing section 13 searches a power source unit that can supply the total current consumption based upon the total current consumption (maximum current consumption) for every rack in the step S16, but this step can be omitted. Instead of omitting the step S16, the maximum supply current value of the power source unit displayed in the field of a power source unit in FIG. 12 can be displayed together with the model information of the power source unit. When a user registers a power source unit, he/she compares the display of the maximum supply current value of the power source unit with the display of the total value of the current consumption, every time a power source unit to be registered is selected, and registers the power source unit whose maximum supply current value exceeds the total current consumption. In this example too, various units registered to the rack may firstly be registered, then, the total value of the current consumption of the units in the rack may be obtained, and thereafter, the power source unit that can be applied to this rack may be selected and registered. This is convenient for a user compared to the conventional case. Further, a user can easily select a power source unit having the maximum supply current value with some degree of allowance.

As for the display of a power source unit as a default, the information of the power source unit stored in the unit information storing section 15 may be displayed so as to be arranged randomly, in the order of an alphabet (in the order of numerical values), or in the order registered in the database without sorting, without considering the relationship with the maximum supply current.

The registering function of a power source unit is not only limited to a new registration of a rack, but also applied to the change of the unit configuration in the rack, as an example of an application of this embodiment. As described above, supposing that a CPU unit in a CPU rack of the PLC is registered, various units are registered, the total current consumption of the units in the rack is obtained, and a power source unit that can be applied to the rack is registered, with the result that the rack configuration is temporarily decided. The PLC tool device 10 can cope with the case where a user plans to change a part of the rack configuration after that. Firstly, the unit that is intended to be changed is selected. In case where the unit is added on, the “unset” in the tree-display on the screen of the unit configuration information in FIG. 9 is selected by a click or the like for newly registering an optional unit. In the case of the exchange of a unit, the unit that is to be exchanged is selected by a click or the like on the screen of the unit configuration information in FIG. 9, and a unit that is to be newly used is selected and registered. In case where the unit is removed from the rack, the unit that is to be removed is deleted by a click or the like on the screen of the unit configuration information in FIG. 9. This process at the processing section 13 is the same as the process at S4 in FIG. 5. The processing section 13 similarly executes the processes at S5 and S6 in FIG. 5, whereby the change can be registered according to need in the rack configuration after the change. Specifically, when the process for changing the rack configuration is performed, the processing section 13 executes the flowchart shown in FIG. 11. For example, in case where the total current consumption of the units installed to the rack is increased as a result of adding on a unit or changing the unit to the one having the greater current consumption, the processes at S16 and S17 are executed in order to change the power source unit to the one having the greater maximum supply current value and to register the changed one. In case where a unit is removed or changed to the one having a smaller current consumption, the total current consumption of the units installed to the rack is decreased, but the processes at S16 and S17 are still executed. Since the total current consumption of the rack is decreased, the following process may of course be performed in which a user is caused to select that the power source unit is unchanged, i.e., that the current power source unit is kept on being used.

In case where the changing process of the unit configuration in the rack is carried out, the processing section 13 may automatically calculate the total current consumption of the units installed to the rack, may compare the result of the calculation and the maximum supply current value of the registered power source unit, and if the total current consumption is greater than the maximum supply current of the power source unit, the display for letting the user to know this situation may be made on the screen. In case where the total current consumption is greater than the maximum supply current value as a result of the comparison, the processing section 13 performs a process for automatically promoting the exchange of the power source unit, as another example. For example, the display screen in FIG. 12 is displayed, and simultaneously, a message for calling the attention such as “please do the operation for exchanging power source unit” is displayed, after the process of the comparison result.

The present invention can be utilized, as an example of an application of this embodiment, for the PLC system construction aiding tool device explained in the conventional example. In this case, the PLC system construction aiding tool device firstly accepts the operation of selecting an optional power source unit by a user, and the power source unit is arranged and displayed at the leftmost of the rack configuration on the screen. Thereafter, it accepts the operation for selecting various units that are to be used in the rack configuration, wherein the selected units are arranged and displayed in the rack configuration on the screen every time a unit is selected. The PLC system construction aiding tool device displays the total amount of the current consumption of each unit in the rack. The processes so far are equal to those in the conventional case. Thereafter, the total current consumption of each unit in the rack is calculated, wherein the result of the calculation is compared to the maximum supply current of the registered power source unit. If it is determined that the total current consumption is greater than the maximum supply current of the power source unit, the PLC system construction aiding tool device makes a display for letting a user to know this situation. As another examples of the display, it is considered that the screen is switched to the operation screen for exchanging a power source unit, or that a message for calling the attention such as “please do the operation for exchanging power source unit” is displayed.

As explained in the example of the application of this embodiment, in case where a process for changing the rack configuration (combination of units) to which the power source unit supplies current is carried out even after the power source unit is registered, the processing section 13 can automatically perform a process for confirming the suitability of the power source unit and a process for re-registering a power source unit according to need.

What is claimed is:

1. A PLC tool device used for constructing and designing a PLC system composed of a combination of various units and a power source unit, comprising:
a control section;
a display section; and
a unit information storing section that stores a type information and a current consumption information of all units and a type information and a supply current information of all power source units;
wherein the control section is configured to execute:
a process for inputting type information of a plurality of unit used for a PLC system that is to be constructed and designed;
a process for obtaining the current consumption information of the plurality of unit by an access to the unit information storing section based upon the inputted type information of the unit, and for calculating a total amount of current consumption of the plurality of unit;
a process for extracting type information of a power source unit that supplies the total amount of current consumption based upon the supply current information stored in the unit information storing section; and
a process for displaying the type information of the extracted power source unit on the display section.

2. A PLC tool device used for constructing and designing a PLC system composed of a combination of various units and a power source unit, comprising:
a control section;
a display section;
an input section; and
a unit information storing section that stores a type information and a current consumption information of all units and a type information and a supply current information of all power source units;
wherein the control section is configured to execute:
a process for inputting a type information of a plurality of unit used for a PLC system that is to be constructed and designed;
a process for obtaining the current consumption information of the plurality of unit by an access to the unit information storing section based upon the inputted type information of the units, and calculate a total amount of a current consumption of the plurality of unit;
a process for obtaining the supply current information of a power source unit which is selected through the input section from the unit information storing section; and
a process for comparing the obtained supply current information and the calculated total amount of the current consumption, and, in case where the relationship between the supply current information and the calculated total amount of the current consumption does not meet a predetermined condition, for displaying this situation on the display section, and, in case where the relationship between the supply current information and the calculated total amount of the current consumption meets a predetermined condition, for displaying this situation on the display section.

3. A PLC tool device of claim 1, wherein the control section further executes:
a process for displaying a list of the type information and the supply current information of the extracted power source units; and
a process for registering the fact that the type information of the selected power source unit can be used in the PLC system that is to be constructed and designed.

4. A PLC tool device of claim 1, wherein
the control section displays on the display section as a default, a power source unit whose current consumption is the smallest in the extracted power source units.

5. A PLC tool device of claim 3, wherein
in the process for displaying the list of the type information and the supply current information of the extracted power source units, the list is displayed in the sorted order based on the supply current of the extracted power source units.

6. A PLC tool device of claim 1, wherein
the unit information storing section stores the type information, the current consumption information and the width information of all units constituting a PLC system and the type information, the supply current information and a width information of all power source units, and
the control section further executes:
a process for obtaining the width information of the selected units and the selected power supply unit used for the PLC system by an access to the unit information storing section, and for calculating the total width of the selected units and the selected power supply unit coupled in a rack; and
a process for displaying the calculated total width on the display section.

7. A PLC tool device of claim 2, wherein
the unit information storing section stores the type information, the current consumption information and the width information of all units constituting a PLC system and the type information, the supply current information and a width information of all power source units, and
the control section further executes:
a process for obtaining the width information of the selected units and the selected power supply unit used for the PLC system by an access to the unit information storing section, and for calculating the total width of the selected units and the selected power supply unit coupled in a rack; and
a process for displaying the calculated total width on the display section.

8. A PLC tool device of claim 6, wherein
the control section further executes:
a process for displaying a list of the type information and the supply current information of the extracted power source units; and
a process for registering the fact that the type information of the selected power source unit can be used in the PLC system that is to be constructed and designed.

9. A PLC tool device of claim 8, wherein
in the process for displaying the list of the type information and the supply current information of the extracted power source units, the list is displayed in the sorted order based on at least one of the supply current and the width of the extracted power source units.
